(19) United States
(12) Patent Application Publication
(10) Pub. No.: US 2005/0138198 A1
(43) Pub. Date: Jun. 23, 2005

(54) Methods, apparatuses, systems, and articles for determining and implementing an efficient computer network architecture

(75) Inventor: John H. May, Richmond, VA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: IT WORKS

(21) Appl. No.: 10/739,376

(22) Filed: Dec. 18, 2003

(51) Int. Cl. G06F 15/16

(52) U.S. Cl. 709/233; 709/203; 709/219

(57) ABSTRACT

Methods, apparatuses, systems, and articles of the invention are used to enhance the efficiency of a computing environment, and to improve its responsiveness to one or more users. In the invention, queuing of data or computer instructions is avoided since this would detract from best case performance for a network environment. The rate-limiting factor for the network is determined, and all constraints imposed by the rate-limiting factor are determined. Business logic is programmed in modules sufficiently small to avoid queuing of instructions. Data is stored by frequency of access and persistence to increase responsiveness to user requests. Requests for data from a data storage device are fulfilled not only with the requested data, but also additional data which is likely to be requested in the navigational hierarchy of presentations to which the requested data belongs.

### FIELD OF THE INVENTION

The invention is directed to determination and implementation of a computer network so as to enhance responsiveness to users thereof. The invention involves the operation of a user device, server, and data storage device connected in communication with one another via one or more networks.

### DESCRIPTION OF THE RELATED ART

In a web-based system such as an application service provider (ASP) architecture, one or more computers are operated by remote users to interact over a network with a server that executes an application on behalf of those users. For example, an on-line banking application may provide the user with the ability to determine his/her bank account balance online. To perform this task, a user operates the web browser to address the home page of his/her bank. The user then selects a link to a lead page for the particular service in which the user is interested, in this case, an account information report feature. The server normally authenticates the user to ensure that the user is authorized to access the data. Such authentication can be performed by the user by entering the password and user name into the computer and submitting same to the server via the network. The server checks to determine whether the user is authorized to access the data. If so, then in response to the user's request, the ASP server requests data of the data storage device, which in turn queries its database for the requested data. The data storage device provides this data to the server, which in turn provides this data to the computer for generation of a presentation on the monitor thereof. The user can thus determine his/her bank account balance by referring to the reported balance in the displayed presentation. This example can be generalized to be typical of many ASPs operating in a variety of contexts: the user makes a request for data, and the server executes its application to request such data from a data storage device, which in turn supplies the requested data to the server for transmission to the computer.

For a variety of reasons, the ASP system can be very slow to respond to the user's request. Often, the popularity and commercial acceptance of ASPs is limited by how responsive the ASP is to the user, and thus whether the user has a good experience when interacting with the ASP. It would be desirable to enhance the performance of ASP systems by increasing their responsiveness to user requests. The user benefits through ease of use in experiencing little or no aggravation when using the ASP system. The ASP benefits through increased user acceptance and use of its ASP system, increasing commercial viability and profitability for the ASP.

### SUMMARY OF THE INVENTION

The methods, apparatuses, systems, and articles of the invention, in their various embodiments and aspects, overcome the disadvantages of previous technologies, including those identified above.

At a general level, the invention can incorporate a network architecture designed by identifying the rate-limiting factor or “bottleneck” within the network. Recognizing the rate-limiting factor, the constraints imposed upon the network components and their functioning are determined, and the network components are programmed and structured to meet those constraints. The network architecture can thus be designed to avoid queuing of code instructions and data caused by a rate-limiting factor, which requires overhead to administer and further reduces system performance below what could otherwise be obtained.

According to one embodiment of the invention, a method comprises determining a rate-limiting factor of a computing environment including at least one user device, a server, and a data storage device. The rate-limiting factor can be a data rate of a connection between the user device and server, instruction and data processing speed of at least one processor in the server, or a data access time required to generate and transmit a data request to the data storage device and receive responsive data from the data storage device at the server, for example. The method can also comprise determining at least one constraint on the user device, server, and/or data storage device based on the rate-limiting factor. The constraints can be related to the time required to download a presentation with data from the server using the user device, the time required to execute a module by the user device, or the time required for the server to access and retrieve data from the data storage device, for example. The method can further comprise determining a navigational hierarchy of presentations, and programming the server to retrieve all data associated with a user for the hierarchy of presentations upon a request for the lead presentation of the hierarchy. Such data thus can be made available to populate the presentations of the hierarchy upon request by the user. The method can further comprise determining the frequency of access of different classes of data; determining whether persistence of the data as always dynamic, initially dynamic but later static, or always static; and storing data in the server and data storage device based on the determined frequency of access of different classes of data and their persistence. The method can further comprise programming the business logic of the server to have modules sufficiently small in size to be executed in response to a data request from a user operating the user device so that the server responds within a predetermined period of time which accounts for the applicable constraints, and is determined to be acceptable to the user. The business logic modules can also be programmed to be sufficiently small in terms of the amount and execution time of software code therein so that they can be completely executed for a data request at the highest expected frequency of data requests in the network environment. The server can be selected to have a multi-processor configuration so that queuing of code instructions and data is avoided. Also, a plurality of Internet protocol (IP) addresses can be used by the server to obtain data from the data storage device, and thereby avoid queuing of requests on the server side awaiting availability of a connection with which to access the data storage device. In addition, the server can be programmed to close a connection to the data storage device as soon as possible after the requested data is received to free the connection and corresponding IP address for use to handle another request.

According to another embodiment of the invention, a method comprises determining a navigational hierarchy of presentations such as web pages, and programming the server to retrieve all data associated with a user for the hierarchy of presentations upon a request for the lead presentation of the hierarchy so that such data can be used to populate the presentations of the hierarchy upon request by the user.

According to yet another embodiment of the invention, a method comprises determining the frequency of access of different classes of data; determining whether persistence of the data as always dynamic, initially dynamic but later static, or always static; and storing data in the server and data storage device based on the determined frequency of access of different classes of data and their persistence.

A system in accordance with an embodiment of the invention comprises at least one user device, a server, and a data storage device. The user device is operable by a user to generate a data request. The server is coupled to receive the data request from the user device via the network, and stores business logic in modules sufficiently small to be executed without queuing of instructions to process the data request. The server is programmed to refer to a cache or data storage unit (DSU) thereof to obtain the data requested by the user. The server stores the data in the cache or DSU according to frequency of access by the user and the data's persistence. If the requested data is not available in the cache or DSU, the server generates a request for the data of a lead presentation and all presentations in a hierarchy thereunder from the data storage unit. The data storage device is coupled to receive the forwarded data request from the server, and retrieves data responsive to the server. The data storage device includes data for a presentation hierarchy along with all data that can be accessed by the user for the lead presentation and presentations linked thereunder. The data storage device provides same to the server over the network. The server can have a multi-processor configuration to assist in preventing queues of computer instructions and/or data. The server can use a plurality of internet protocol (IP) addresses to address data in the data storage device to avoid queuing of data requests. The server can close connections to the database as soon as the responsive data is received from the data storage device to assist in preventing queuing of requests for data.

An apparatus in accordance with one embodiment of the invention comprises a server having a memory and a data storage unit (DSU). The server is programmed to store data used by such server amongst the memory and DSU according to frequency of access and persistence of the data. If data associated with a variable is always dynamic, then it can be programmed in the business logic executed by the server, and not persisted in the memory, DSU, and/or external data storage system. If data is initially dynamic but later becomes static, then it can be stored in a relatively fast memory device such as cache or DSU while it is dynamic, then later stored when static, possibly in a less fast memory device such as the server's DSU or the external data storage device, according to its frequency of access. In general, the server can store data that is accessed on a high frequency basis in cache, data that is access less frequently in a DSU or hard drive of the server, and data that is accessed even less frequently in an external data storage device. The business logic modules executed by the server can be sufficiently small so as to reduce or avoid queuing of computer instructions and/or data to be processed by one or more processors of the server. In addition, if the server receives a request for data from the user and does not have such data, the server can be programmed to retrieve not only the specific data requested by the user from an external data storage device, but also data that the user has not yet requested but is likely to request in the near future. For example, if a data request is made for the lead presentation in a hierarchy of presentations such as web pages, then the server can be programmed to retrieve all data for these presentations from the server. Alternatively, the server can retrieve data for a limited set of presentations that the user is likely to request in the future. The data can be stored in the external data storage device in a user profile identified by credential data such as a user name and password, digital certificate, etc. that are received by the server from the user device and forwarded to the database storage device for identification of the data pertinent to the user making the data request. These features can be used to enhance responsiveness of the apparatus to a user request.

A data storage device comprises a data storage unit for storing data in at least one user profile. The data is associated with an index identifying a presentation hierarchy to which the data belongs, and at least one variable name identifying a field location of the respective presentation for population with the data. The data storage device can also comprise a processor coupled to the data storage unit, which is responsive to an external request for data, retrieves the requested data and any additional data included in the corresponding presentation hierarchy, and responds to the external request for data by providing the requested and additional data. The data storage device can receive the external request from a server over a communications network.

In another embodiment of the invention, a data storage medium stores data in accordance with the frequency of access and persistence of the data. Data can be selectively stored in the data storage medium in dependence upon whether the data is accessed on a relatively low, medium, or high frequency basis. The data storage medium can be a cache that stores data accessed on a high frequency basis, a data storage unit (DSU) or hard drive that stores data accessed on a medium frequency basis, or a data storage device that stores data accessed on a low frequency basis. The persistence of the data can include dynamic, static, and initially dynamic and later static. Dynamic data is not persisted, but is programmed as a variable into business logic. Static data is persisted according to its frequency of access. Initially dynamic and later static data is persisted only after it becomes static, in accordance with its frequency of access while static and dynamic. During a session, however, data requested by the user and some or all other data that is likely to be access by the user, are retrieved from the DSU or external storage device for storage in the server's cache. This data can remain in the cache where it can be rapidly accessed by the server until the session with the user is terminated.

In an additional embodiment of the invention, a processor-readable medium stores data in at least one user profile, which data is associated with an index identifying a presentation hierarchy to which the data belongs, and at least one variable name identifying a field location of the respective presentation for population with the data.

In yet another embodiment of the invention, a processor-readable medium stores a computer program responsive to a request for data and retrieving the requested data and additional data included in a corresponding presentation hierarchy. The processor responds to the request for data by providing the requested data and additional data. The request can be generated by a server and received by the processor from the server over a communications network.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1 and 2 are a computing environment comprising one or more user devices, a server, and a data storage device, which can operate in an application service provider (ASP) context;

FIG. 3 is a flow diagram of a method of obtaining increased efficiency and enhanced responsiveness to user requests, in accordance with the invention;

FIG. 4 is a block diagram of a data storage device and data structure of the invention, indicating how data for a presentation hierarchy can be retrieved in a single request in order to speed responsiveness to a user request;

FIG. 5 is a table indicating data storage location of data in dependence upon its frequency of access and persistence;

FIG. 6 is a view of the cache structure of the server in accordance with the invention;

FIGS. 7A-7C are diagrams indicating the effect of queuing and latency on data processing efficiency;

FIG. 8 is a block diagram indicating the effect of aliasing through use by the server of multiple IP addresses to access the data storage device;

FIG. 9 is a view of an exemplary presentation display on a user computer to display the results of a data request initiated by a user;

FIG. 10 is a flow chart of processing performed by the user device;

FIGS. 11 and 12 are a flowchart of processing performed by the server;

FIG. 13 is a flow chart of processing performed by the data storage device;

FIG. 14 is a view of a user layer, server layer, and data layer executed on various hardware platform configurations.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Definitions

“And/or” refers to one, some, or all of the things meant by the word(s) preceding and succeeding such phrase. Thus, “user device, server, and/or data storage device” means “the user device, server, or data storage device, the user device and server, the user device and data storage device, the server and data storage device, or all of the user device, server, and data storage device.”

“Browser” refers to an application such as Internet Explorer® software, Netscape® software, or Mozilla® software that enables a computer to communicate with a remote server.

“Cache” refers to a data storage location within a memory.

“Data storage device” refers to a data storage system that has a database server or management software, in addition to a processor and data storage unit, for storing a database.

“Data storage unit” refers to a hard-disk drive unit, mass data storage device, or other such device.

“Input device” can be a keyboard, mouse, wand, trackball, touch-pad, or other such device operated by the user to input data and commands to a processor.

“Memory” generally refers to random-access memory (RAM), dynamic random access memory (DRAM), synchronous dynamic RAM (SDRAM), double data rate random access memory (DDR RAM), or any other memory providing relatively fast access to data.

“Persist” refers to storage of data that is static to make it available for retrieval at a point in time after its storage.

“Presentation” is a display, sound, vibration and/or other output of a device that can be sensed by a human user. The presentation can be generated from one or more data, text, sound (e.g., voice or music), graphics, vibration (e.g., a silent vibration alarm), and other files. “Presentation” also includes multimedia files including more than one media format, such as a video file which has both sound and streaming graphics. The file can comprise computer code segment(s) including one or more objects, applets, files, etc. that when executed by a processor generate humanly-sensible output on an output device.

“Processor” refers to a microprocessor, microcontroller, a programmable gate array (PGA), field programmable gate array (FPGA), programmed array logic (PAL), programmed logic array (PLA), or any other such instruction and data processing unit.

“Network” refers to a digital network such as the Internet, Internet II, Internet III or more advanced comparable network, a local area network (LAN), a wide area network (WAN), a metropolitan area network (MAN), a cable network, a wireless network such as cellular telephone, satellite, and radio, and others, and combinations of the above or other types of networks.

“Non-Volatile Memory” or “NVM” refers to a memory that retains data even if the power to such memory is removed.

“Output device” can be a monitor, browser display, light, liquid crystal display (“LCD”), light-emitting diode (LED), diode array, flat panel display, cathode ray tube (“CRT”), speakers, vibration generator, or other device for generating a display, sound, vibration and/or other presentation based upon the execution of the presentations by the processor.

“User Device” is generally a personal computer, personal digital assistant (PDA), laptop computer, a web access device, telephone handset, or other such device.

“(s)” means one or more of the things meant by the preceding word. Thus, “constraint(s)” means “one or more constraints.”

General Overview of the Inventive System

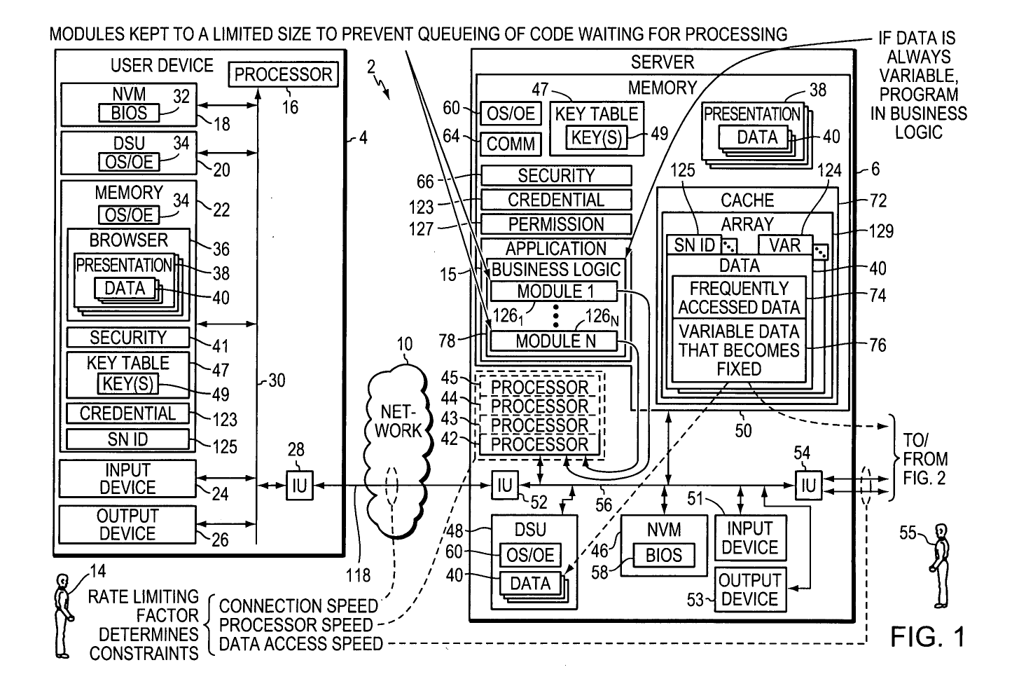

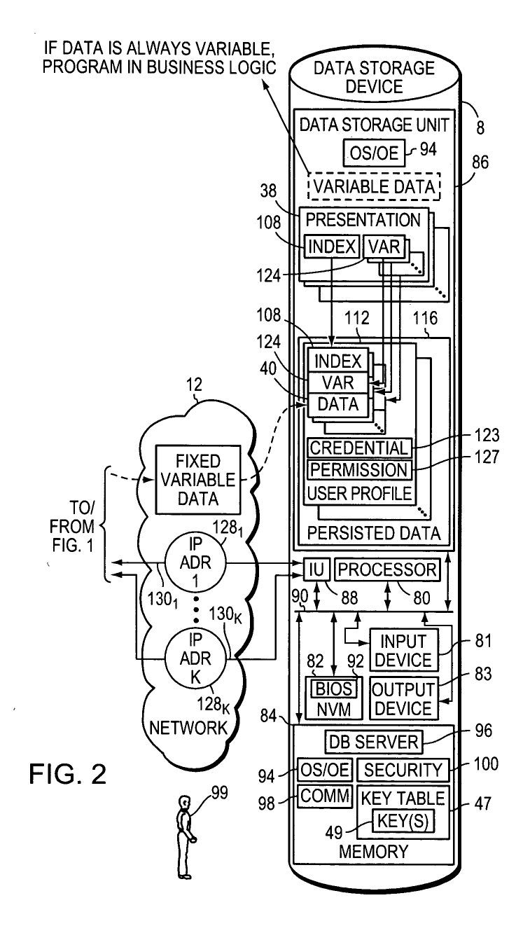

FIGS. 1 and 2 are views of a computing environment 2 in accordance with one exemplary embodiment of a disclosed invention. The computing environment 2 generally comprises one or more user devices 4, a server 6, and a data storage device 8. The user device 4 and server 6 are coupled to communicate with one another via the network 10. The server 6 is coupled to communicate with the data storage device 8 via the network 12. The network 10 can be a public communications network such as the Internet or similar network. The network 12 can be the same as the network 10, or alternatively, can be a local area network (“LAN”), a wide area network (“WAN”), a metropolitan area network (“MAN”), wireless networks such as cellular telephone, radio, or satellite, or other such network, or combinations thereof.

In the implementation of the invention presently considered or expected to be most typical, the user device 4 will be operated by user 14. The user device 4 can thus be a personal computer (“PC”), personal digital assistant (“PDA”), a web-access device, a browser-based cell telephone or pager, or any other such device now existing or developed in the future. Although only one user 14 and corresponding user device 4 is shown in FIG. 1, there can be, and in many applications will be, numerous users of respective user devices operated to access the server 6.

The server 6 hosts an application 15 with which the user 14 interacts. Associated with the application 15 are various data 40 stored in the data storage device 8. Hence, user device 4, server 6, and data storage device 8 can be considered to be part of what is commonly known as an application service provider (“ASP”) architecture. As one example, the user 14 can be a customer of a bank who desires to use the application 15 to determine his/her account balance based on data stored in the data storage device 8. As yet another example, the user 14 can be an employee of an organization that desires to use the application 15 hosted by the server 6 to access retirement benefits information stored in data contained in the data storage device 8. However, these examples do not of course exclude the possibility of use of the embodiments and aspects of the invention in other contexts. The teachings herein are transferable to virtually any ASP context, and possibly other contexts such as peer-to-peer networks as well.

Returning to consideration of the user device 4, such user device comprises a processor 16, a non-volatile memory 18, a data storage unit (DSU) 20, a memory 22, an input device 24, an output device 26, and an interface unit (“IU”) 28. The processor 16 is coupled to communicate control commands, signals, and data to and from the units 18, 20, 22, 24, 26, 28 via the bus 30. The non-volatile memory 18 can be a read-only memory (“ROM”) or similar device that stores data regardless of whether power is supplied to such unit. The non-volatile memory 18 stores the basic input/output system (“BIOS”) 32 which the processor 16 executes upon startup in order to load the operating system/operating environment (“OS/OE”) 34 stored in the DSU 20. The DSU 20 can be a hard-disk drive unit or other mass storage device. The processor 16 retrieves the OS/OE 34, loads same in relatively fast-access memory 22, and executes it in order to prepare the user device 4 to launch an application, such as browser 36, desired by the user 14. The memory 22 can be random-access memory (“RAM”) or other similar memory which provides relatively fast access to data and code instructions to the processor 16. In this exemplary embodiment, the user 14 launches browser application 36 to display one or more presentations 38 such as web pages using the browser. The memory 22 also stores data 40 which is retrieved from the server 6 and/or data storage device 8. The data 40 can also be generated by the processor 16 as it executes the browser application 36 and presentations 38 therein. Input device 24 can be a keyboard, mouse, wand, trackball, touch-pad, or other such device operated by the user 14 to input data and commands to the processor 16. The output device 26 can be a monitor, liquid crystal display (“LCD”), diode array, flat panel display, cathode ray tube (“CRT”), or other device for generating a display or presentation based upon the execution of the presentations 38 and the browser 36 by the processor 16. The input device 24 and output device 26 together may be considered a user interface as it provides the interface enabling the user 14 to communicate and interact with the processor 16.

Interface unit 28 can be a modem such as a dial-up, digital subscriber line (“DSL”), cable, gateway, network interface card, or other such device that enables the user device 4 to communicate with the server 6 over the network 10. The network 10 can be comprised of a plurality of nodes, such as computers, servers, switches, routers, gateways, bridges, and other devices, that enable communications via different paths. In the case that the interface unit 28 is a modem, the network may include an Internet Service Provider (“ISP”) to which the user 14 dials in, in order to establish a connection with the network 10, in this example, the Internet. The server 6 comprises processor(s) 42, 43, 44, 45. In one embodiment, the server 6 has a multi-processor configuration. Dual- or quad-processor configurations are commercially available. These additional processors are indicated in a broken line to indicate that they are optional features of the server 6. The server 6 also comprises non-volatile memory 46, data storage unit (“DSU”) 48, memory 50, input device 51, and output device 53. In addition, the server 6 comprises interface unit 52 to enable communications with the user device 4 via the network 10, and interface unit (“IU”) 54 to enable communications with the data storage device 8 via the network 12. The processor(s) 42, 43, 44, 45 communicate with units 46, 48, 50, 51, 52, 53, and 54 via the communication bus 56. The non-volatile memory (“NVM”) 46 stores the BIOS 58 which the processor(s) 42, 43, 44, 45 execute in order to load the OS/OE 60 and related utilities and libraries. More specifically, the processor(s) 42, 43, 44, 45 loads the OS/OE 60 into the memory 50. In addition, the DSU 48 stores data 62, which is required on a mid-frequency basis. The memory 50 can also be provided with a communication module 64, which enables communication with the user device 4 and/or data storage device 8 via respective networks 10, 12. The communication module 64 can be a web server, for example, including related transport control protocol/Internet protocol (“TCP/IP”) stacks. The security module 66 stores encryption and decryption software for encrypting outgoing communications to user device 4 or data storage device 8, and decrypting incoming communications from the user device 4 and data storage device 8. The security software 66 can be provided as a security layer such as the secured socket layer (“SSL”) or public/private key encryption/decryption schemes such as “pretty good privacy” (PGP) in common use. To assist with encryption and decryption, the memory 50 can store a key table 43 having keys 45. Using appropriate key(s) 45, the processor(s) 42, 43, 44, 45 can encrypt communications outgoing to the user device 4 and/or data storage device 8, and decrypt communications from the user device 4 and/or data storage device 8. The memory 50 also stores a cache 72 containing relatively frequently accessed data 74 as well as data 76 which is initially variable but later becomes fixed. In addition, the memory 50 stores the business logic 78 constituting the application hosted by the server 6, with which the user 14 interacts by operating the user device 4. The business logic 78 contains modules 126₁-126_{N}, N being a positive integer. The input device 51 and output device 53, in conjunction with the processor(s) 42, 43, 44, 45, provide a user interface so that a system programmer or administrator 55 can program the application 15 and its business logic 78, set permission data 127 determining a user's rights and privileges with respect to data, resource, and service access, etc. The IUs 52, 54 can be network interface cards (“NICs”), modems, transceivers, or other such devices. The IU 52 is coupled to the IU 28 and user device 4 via network 10 to permit communication from the server 6 to the user device 4, and vice versa. Similarly, the IU 54 of the server 6 is coupled to the data storage device 8 via the network 12.

Turning now to the data storage device 8 of FIG. 2, such system comprises a processor 80, non-volatile memory (“NVM”) 82, memory 84, input device 81, output device 83, data storage unit 86, and IU 88. The processor 80 can be connected to the units 81, 82, 83, 84, 86, 88 via a communication bus 90. The NVM 92 stores the BIOS or kernel 82 executed by the processor 80 in order to load the OS/OE 94 into the memory 84. Once the OS/OE 94 is running, the processor 80 launches the database server 96. The database server 96 administers storage of the data stored in DSU 86. The database server 96 can be one of numerous software packages such as Oracle® 9 or 10 Series, SQL- or SQL7-based, or other software. The processor 80 can execute the communication module (“COMM”) 98 to communicate with the server 6 via the network 12. The memory 84 can also store security module 100 which uses key table 47 and associated key(s) 49 in order to encrypt and decrypt communications received from or transmitted to, respectively, the server 6 by execution of the communication module 98 and use of IU 88. The DSU 86 stores presentations 38 having indexes 108 which are used to identify hierarchical groups of presentations. Indexes 108 are associated with respective data 40 of respective user profiles 112. Credential data 131 is also stored in the DSU 86 as persisted data 116. The input device 81, output device 83, in conjunction with processor 80 and database server 96 can be used to provide a user interface for database administrator 99. These units thus provide the capability to program the database server 96 and associated query logic, to index presentation hierarchies, etc. Having thus described the basic elements of the computing environment 2, specific description is now provided with respect to those features that enhance the ability of the user 14 to operate the user device 4 to interact with the server 6 and data storage device 8 via networks 10, 12.

Determination of Rate-Limiting Element in the Network

The first step in improving performance and response time of the computing environment 2 for the user 14 is to determine the rate-limiting element in the computer network. The rate-limiting element is the element which determines the maximum throughput of data and/or presentations provided between the user device 4, server 6, and data storage device 8. In many cases, the rate-limiting element will be the speed of connection 118 establishing communication between the user device 4 and the server 6, the processing speed of the processor(s) 42, 43, 44, 45, or the data access speed associated with connections 130₁, . . . , 130ₖ, k being a positive integer. In most practical contexts, in present computer networks, it is normally the minimum data rate on connection 118 between the user device 4 and server 6 that is the rate-limiting factor. For example, if the interface unit 28 is a typical dial-up modem, the data rate capable on such modem is nominally 56 kilobits per second. Although this is relatively slow as compared to processor speeds and data access speeds of present commercial devices, such data rate must be discounted even more significantly in order to determine the actual data rate capable of a dial-up modem. Factoring in performance discounts for non-data bits in the datastream, network distortion, overhead for security-related encryption and decryption, and other applicable factors, the actual performance of the dial-up modem can be significantly lower than the nominal value. Thus, to determine the maximum effective data transfer rate associated with the 56 kilobits per second dial-up modem, the following computations can be made.

Assuming a nominal modem speed of 56 Kbps, this number is first discounted to account for processing overhead and administration associated with maintaining the connection. Next, a discount is provided for the network distortion typical for the connection 118. For example, network distortion can be caused by line quality, interference, cross-talk, the quality of the equipment used to transmit the data signal, and other factors. Thus, given the non-perfect nature of communication networks, the normal operation of the modem will require it to retransmit data to the server 6. Retransmission of data, of course, degrades the effective data rate of the connection 118. Furthermore, in the context in which security is used, some of the data rate of the connection 118 can be consumed in overhead associated with encryption and decryption of the data. Thus, the effective data rate of a 56 Kbps modem can be significantly reduced significantly from its nominal value considering these factors. The determination of the effective data rate is important to determining the factor that limits the system performance. Although some users 14 can have access to DSL or cable modems providing much faster data speeds if a significant number of the users 14 have dial-up modems, the network architecture must be designed for the lowest connection rates if those users are to have effective access to the application 15 provided by server 6 and data provided by data storage device 8.

An important feature of the invention is to avoid queuing of data and instructions caused by the rate-limiting element. For example, if the processor(s) 42, 43, 44, 45 provide data and/or presentations at a faster rate than the rate-limiting element can process these instructions and data, queuing occurs which requires administration overhead that can actually decrease the minimum data rate over the connection 118 to even lower than its fully discounted value. Thus, by preventing queuing of code instructions and data, the system performance can be enhanced.

The following table is a typical calculation for determining the fully-discounted data rate:

TABLE 1
Discount Factors for Data Rate of Network Communication

| | Nominal or |
|---|---|
| | Discounted |
| Nominal Data Rate and Discount Factors | Data Rate (kbps) |
| Nominal Data Rate of Dial-Up Modem = | 56.0 |
| Discount to Data Rate to Account for Non-Data Bits = | 44.8 |
| Discount for Network Distortion = | 35.8 |
| (assuming 20% Packet Resend) | |
| Discount for Security Overhead = | 21.5 |
| (assuming a 40% decrease for SSL processing) | |

Hence, the cumulation of account factors applied to the nominal data rate produces a data rate of 21.5 kbps is far below the nominal data rate of the modem. By defining and constructing the network 2 with the fully discounted data rate, the network can be constructed to avoid queuing or bottlenecks of data and instructions awaiting processing, which will further degrade performance even below the fully discounted data rate of the limiting element.

The twenty percent (20%) discount for actual data rate accounts for the fact that the communication protocol for a dial-up modem uses two (2) bits of non-data and eight (8) bits are data for each group of ten (10) bits. Accordingly, the actual data rate is eight data bits divided by ten total bits, which equals 0.8=80% of the nominal data rate. Thus, the nominal data rate has to be discounted by 100%-80%=20% to account for the fact that there are non-data bits in the data stream.

Packet communication networks normally require repeated transmission of previously sent data. For example, communications retransmission may be necessary if the line quality, cross-talk, noise, dispersion, attenuation, equipment quality, wear, or age, and a wide variety of other factors, cause garbling or loss of transmitted data. In such event, most packet communication protocols provide for retransmission of previously sent data. In this example, a 20% discount for data retransmission is assumed. Actual discount can vary significantly depending upon the particular implementation of the network, the particularly equipment used, etc. Hence, one way to determine network distortion is to determine the number of bits transmitted per unit time at the user device 4 to the server 6 with the number of bits actually received by the server 8, and vice versa from the server 6 to the user device 4, to determine the average number of data bits per unit time that are actually transmitted and received taking into account network distortion effects. In this example, network distortion of twenty percent (20%) is assumed, lowering the data rate to 35.8 Kbps.

Also, overhead for security operations such as encryption and decryption of data may slow the data rate over the connection 118 for data transmitted from the user device 4 to the server 6, and vice versa. For example, assuming an overhead for security operations of twenty (20%) of the data rate, the effective data rate is further slowed to 21.5 Kbps. Thus, the accumulated discounts can greatly reduce the effective data rate, in this example to less than half of the nominal data rate of the modem. Although the specific discounts described above should in no way be considered applicable to all potential implementations of the computing environment 2, and applicable discounts must be determine for each individual implementation of the network based on the types of equipment, software, and services used to implement the network, and their capabilities and characteristics. Nonetheless, persons of ordinary skill in the art should be able to determine fully discounted data rates for specific implementations based on this disclosure and information available to such persons as of the filing date of this disclosure.

Although not normally the case in present communications network environments, if circumstances in the future were to become such that the processor(s) 42, 43, 44, 45 constituted the limiting factor in network communications, then the data transfer rates of user device 4 via connection 118 and the response time required for data storage device 8 via connections 128₁-128ₖ must be controlled so as not to exceed the capabilities of the processor(s) to process instructions and data provided by the user device 4 and data storage device 8. This avoids queuing of data and code instructions which further deteriorates data processing below the best case scenario, thus improving responsiveness to user requests for data. Alternatively, the number of processor(s) should be increased sufficiently to handle data requests from the server 6 without queuing of data requests.

Likewise, if the response time of the data storage device 8 is the rate limiting factor (again, not often the case in present network environments), then the server 6 should be programmed to avoid queuing of data requests that cannot be handled given the response time of the data storage device 8. Alternatively, the number of processors used in the data storage device 8 should be increased. Queuing will deteriorate the ability of the data storage device 8 to respond below its best case response time due to administrative overhead required of the data storage device to manage the queue.

Determine Constraints on Network Components

Once the rate-limiting factor is determined, its impact upon the network 2 should be considered. The worst case time required to download a presentation from the server 6 to the user device 4 is the number of bits in a presentation divided by the fully discounted data rate. Assuming a typical presentation, such as a web page, has 56 kilobits of data in it, the time required to download a web page from the server 6 to the user device 4 via connection 118 is:

$$\frac{56 Kbps}{21.5 Kbps} \approx 2 Seconds$$

Thus, when the user 14 operates the user device 4 to download a web page from the server 6, the worst case scenario produces a response time of approximately two seconds. Hence, the processor(s) 42, 43, 44, 45 of the server 6 must execute all instructions and retrieve all data necessary to generate and transmit the web page to the user 14 via user device 4 and network 10 within two seconds in order to attain the best possible response time for the user given the constraints on the system. However, the processor(s) 42, 43, 44, 45 should not load the transmission buffer of the communications module 64 to the point at which it overflows, thereby consuming additional processing time to manage the overflow. In addition, the data access time for the server 6 to retrieve any data needed for the web page must be retrieved from the data storage device 8 within the two second design window, and preferably well before then to permit the processor(s) 42, 43, 44, 45 the time necessary to retrieve and/or generate the web page and incorporate any related data therein, and download same to the user device 4. However, the rate at which the data storage device 8 responds with data should not exceed the processor(s) 42, 43, 44, 45 ability to process it, which would result in queuing of data in the memory 50 that the processor(s) 42, 43, 44, 45 would require it to expend additional processing power in order to manage.

Although not generally the case in current computer networks, if the processor(s) 42, 43, 44, 45 were determined to be the rate-limiting element(s), then the requests from one or more user devices 4 would have to be sufficiently limited not to exceed the server's processing power. In order to achieve target performance, it can be necessary to select a server with multiple processors, add one or more additional processors to the server, or to add one or more additional servers to accommodate requests from the user device(s) 4. Moreover, the data storage device 8 may have to be programmed so that its response time is sufficiently slow so as not to exceed the ability(ies) of the processor(s) to receive the responsive data.

Assuming the data storage device 8 was determined to be the rate limiting element in the computing environment 2, then the processor(s) 42, 43, 44, 45 can be programmed so as not to generate requests to the data storage device 8 at a rate that exceeds the ability of such system to respond. This will avoid queuing of data requests which will consume processing power on the part of the data storage device 8 in order to manage the queued data, further slowing response times. To achieve a target data access time, it may be possible to add one or more additional database servers and/or DSUs, or additional data storage devices, in order to meet the required data access time. For example, it is possible to divide different classes of data for storage in different data storage devices. However, storage of the same data into different memory locations, whether within the same or different data storage devices, should be avoided if possible to reduce the overall size of the stored database.

Presentation Navigation

One key element to enhancing responsiveness to a user request for a presentation is to retrieve the data from data storage device 8 not only for the requested presentation, but also for all others related to it, anticipating that the user will eventually access one or more of those presentations as well. This strategy can be used to greatly enhance the responsiveness of the server 6 and the data storage device 8 to requests from the user device(s) 4.

In order to implement the strategy, the navigational structure of the presentations (such as web pages) must be determined. The presentations may be designed with a particular flow in mind for the user. For example, one page might be a home page of a bank with links to various services, like “check account balance.” Upon the user's operation of the user device 4 to select the “check account balance” hyperlink from the home page, the next presentation may require input of user name and password. However, anticipating that the user will provide the appropriate user name and password, the server 6 can retrieve all presentations and associated data that may follow the login presentation. Thus, upon entry of user name and password, the server 6 responds with an account balance presentation with data indicating the user's account identification number, balance, date of computation of the balance, etc. Thus, the user 14 experiences no delay other than that necessarily imposed by the rate-limiting element of the computing environment 2.

To generalize from this example, the first step in accomplishing enhanced response to a user request for a presentation and related data is to determine the navigational structure of the presentations. In a case in which the presentations are constructed to achieve a particular objective for a website during development, such determination of the presentation flow and hierarchy is a natural part of the process. Alternatively, if the presentations and the data variables included therein have been previously established, examination of the presentations or simple use of the system can reveal the navigational structure of the presentations and data therein. For example, by reviewing the source code of a presentation, one can determine the linked files by locating the hyperlink reference tag “href=” and the following data indicates the domain and path to the file for a resource such as a presentation. Alternatively, by executing the presentation on a computer and activating the hyperlinks, the related presentations can be reviewed and identified along with the corresponding data for those presentations. In order to accomplish this objective, the presentations and related data stored in the DSU 86 can be related by unique index 108. More specifically, the metadata associated with the presentation 38 can be coded to include a unique index 108 that identifies that presentation and all other presentations that are related to it. In addition, in correspondence with a user profile 112 for each user 14, related data 40 for each item of data related to a presentation can be associated with the same index 108. In this manner, when the database server 96 receives credential data 123 such as a user name and password from the user 14 via the user device 4, server 6, and networks 10, 12, the processor 80 can confirm that the user is authorized to access such data. More specifically, the user 14 “logs in” with the server 16 by providing credential data 123 such as a user name an password, digital certificate, etc. The server 6 authenticates the user's credential data 123 by comparing it with corresponding data stored in the server. If the user is not authenticated, then the server 6 rejects access to the user 14 by transmitting an error message to the user device 4 along with a reason for the refusal, for example, “username not found” or “password not found.” If the user 14 is authenticated by the server 6, then such server 6 establishes a session for the user 14 and transmits a session identifier 125 to the user device 4 for use in identifying the session in subsequent communications with the server. In addition, the server 6 retrieves permission data 127 which defines the right(s) and privilege(s) of the user 14 in relation to the data 40, the portions of the application 15 which the user is authorized to access, and other services and resources provided by the server 6. The server 6 also retrieves from the database 8 all data 40, and possibly also related variable names 124, from the corresponding user profile 112 that are listed under the index 108 for the requested presentation hierarchy from the data storage device 8. This data 40 can be stored by the server 6 as frequently accessed data 74 that is likely to be requested by the user 14 based on the nature of the application 122. The server 6 can retrieve this data 40 from the corresponding user profile 112 stored in the data storage device 8. More specifically, the server 6 can store this data 40 in correspondence with the session identifier 125 in multi-dimensional array 129. The array 129 is established in cache 72 upon boot-up of the server 6. The memory space reserved for the array 125 can be limited, for example, to no more than half of the cache 72 so that the remainder of the cache can be used for other purposes. Thus, the presentation index 108 and/or variable 124 can be used to retrieve the corresponding data 40 for population of respective fields of the presentation 38 so that the same can served to the user device 4 via the server 6 and networks 10, 12. The array 129 is thus provided with the session identifier 125 and corresponding user data 40. The data 40 can comprise frequently accessed data 74 and/or dynamic-to-static data 76. When the user 14 requests subsequent data or presentation, the server 6 can retrieve such data 40 from cache 72 using the session identifier 108. Accordingly, the server 6 provides this data to the user device 4 much more quickly than it otherwise would due to the fact that the data 40, 76 was stored in the server's cache 72 as soon as it is evident that the user intends or is likely to access data in a presentation hierarchy. For example, the user's intent to access a particular presentation hierarchy can be manifest at the time that the server 6 authenticates the user by the nature of the application 115. Alternatively, the user's navigation can indicate what data 40 the user intends to access before the user has generated a request for such data. For example, the user's activation of a web page hyperlink can indicate that the user intends to access a particular function or portion of the application 115, so the server 6 can be programmed to retrieve the corresponding data, and optionally also the presentation hierarchy, in response to the user's activation of the hyperlink.

To enable the server 6 to retrieve the data for not only the first presentation but the entire hierarchy following thereunder, the business logic 78 in server 6 is programmed accordingly. Once the presentations of a hierarchy are indexed and the variables thereunder associated with respective data, the business logic module 78 can be programmed to retrieve all corresponding data for a hierarchy of presentations upon the user's request to access the first presentation in that hierarchy. This feature of the disclosed invention provides significant enhancement of response time experienced by the user 14 upon generating a request for data from a presentation, and particularly for subsequent requests for presentations and data within the same hierarchy. For subsequent requests within the same presentation hierarchy, the server 6 has already obtained the necessary data from the data storage device 8 so that it can readily populate corresponding fields of the presentation and respond to requests from the user device 4 by serving the presentation with populated data thereto.

Classification of Data by Frequency of Access and Persistence

Data is stored in the computing environment 2 in accordance with its frequency of access and persistence. If data is always variable, then it is programmed in business logic 78 as opposed to storing such data in the data storage device 8. Coding such data is variable in the business logic 78 avoids unnecessary read operations from the memory 50, DSU 48, and/or data storage device 8 which can unnecessarily slow overall system performance. Conversely, data which is static is stored according to its frequency of access. If such data is frequently accessed, then it is stored as data 74 in the cache 72 for ready availability to the processor(s) 42, 43, 44, 45. On the other hand, if the data is infrequently accessed, e.g., archival data, then this data is stored as data 40 in the data storage device 8. Intermediate these two cases, data which is accessed on a medium frequency can be stored in the DSU 48 and/or other parts of the memory 50 other than the cache 72. A different class of data is that data which is initially variable but becomes fixed. For example, a running total of bank account deposits over a month can be totaled to obtain the monthly sum of deposits. Thus, the running sum is initially variable but after all deposits for the month have been added, the final monthly sum of deposits can be static. If the monthly sum is frequently accessed, then it can be stored in the cache 72 as data 76, both while the data is dynamic as the sum is being determined, as well as after the final sum is obtained by the processor(s) 42, 43, 44, 45. If the data is accessed on a medium frequency basis, then this data can be stored in the DSU 48 and/or memory 50 while the data is in dynamic form, and then stored in the DSU 48 as data 62 once such data becomes static. Finally, if the variable data that later becomes fixed is accessed by the processor(s) 42, 43, 44, 45 on an infrequent basis, then such processor(s) can store this data in the DSU 48 while it is dynamic and later in the data storage device 8 when it becomes static. In general, if a user 14 has requested data 40 within a session, then such data 40 will be located in the cache 72 in correspondence with the session identifier 125 that has been assigned to the user's session by the server 9. In addition, data 40 for all presentations within the hierarchy of user-requested data are stored in correspondence with the session identifier 125 in case such data is requested by the user. Upon termination of a session, the server 6 makes the cache memory space used during the session available for another user session.

Server Configuration and Programming for Efficient Response to User Requests

One important consideration to enhancing the speed of the processor(s) 42, 43, 44, 45 is to limit the blocks of code that the processor(s) is required to execute to be sufficiently small to prevent queuing of code instructions. The queuing of such code requires management overhead of the processor(s) 42, 43, 44, 45 and is thus to be avoided in order to enhance response times experienced by users 14 generating requests for data. One way in which this can be done is to determine the average time between requests which require launching of one or more of modules 126₁-126_{N}, and limiting the module to only code instructions which can be executed within such time interval or less. Such determination can be for the highest actual or expected network traffic for the website, which can coincide with a particular time of day, season of the year, occurrence of an event of interest to users, etc. Hence, the processor(s) has on average the capability to avoid queuing of modules awaiting execution by one or more of the processor(s) 42, 43, 44, 45. In addition, to avoid queuing, a multi-processor environment is preferred for the server 6. In other words, if more than one of the processor(s) 42, 43, 44, 45 is available to execute code, then multiple threads of code instructions for modules 126₁-126_{N} can be running at any given point in time. This helps to avoid queuing of modules awaiting execution. Thus, dual- or quad-processor configurations are preferred over single processor configurations for the server 6. Furthermore, it should be noted that it can be possible to break a request into multiple instances of a module in order to achieve faster response times to a user request. For example, one module 126 can be executed by a processor to populate a portion of a presentation while another processor executes a module to populate another portion of the presentation. By processing modules for the same task in parallel, faster response times to a user request can be achieved.

Access to Data Storage Device

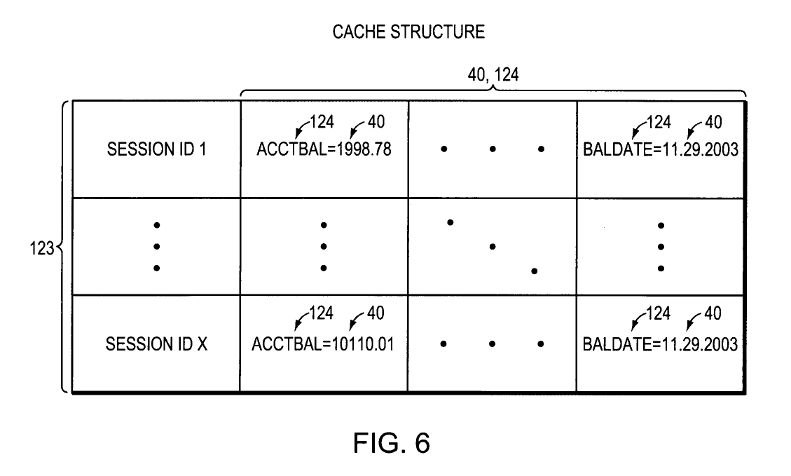

The server 6 uses aliasing to address the data storage device 8 to retrieve data therein. More specifically, the server 6 generates requests for data using one of a group of IP addresses 128₁-128_{K}. The use of multiple IP addresses to address the data storage device 8 prevents queuing of requests for data. In addition, once the data has been received by the server 6 from the data storage device 8 for an open connection, the server 6 is programmed through its business logic 78 to close the connection 130₁-130_{K}. This prevents connection paths 130₁-130_{K} from being occupied longer than is necessary to transmit the data requests from the server 6 to the data storage device 8 and to receive the data that is responsive to that request from the data storage device to the server over a respective connection 130₁-130_{K}. Use of a plurality of IP addresses 128₁-128_{K} also provides the ability to partition data. For example, the data can be partitioned and stored in different data storage units 86 addressable with different IP addresses. Thus, while FIG. 1 only shows one DSU 86, there could be a plurality of such units as addressed subsequently with respect to FIG. 6.

Security

The user device 4, server 6, and data storage device 8 can be provided with key table 47 including key(s) 49. During communication between the user device 4 and the server 6 or the server 6 and the data storage device 8, one of the keys 45 is selected for use to encrypt the data to be transmitted by respective security modules 41, 66, 100 as they are executed. This data is received by the receiving equipment and decrypted using the corresponding key from key table of the receiving device. For example, the security modules can be implemented so as to execute the well-known secure socket layer (SSL), public/private key encryption/decryption or pretty good privacy (PGP) security, for example.

General Method

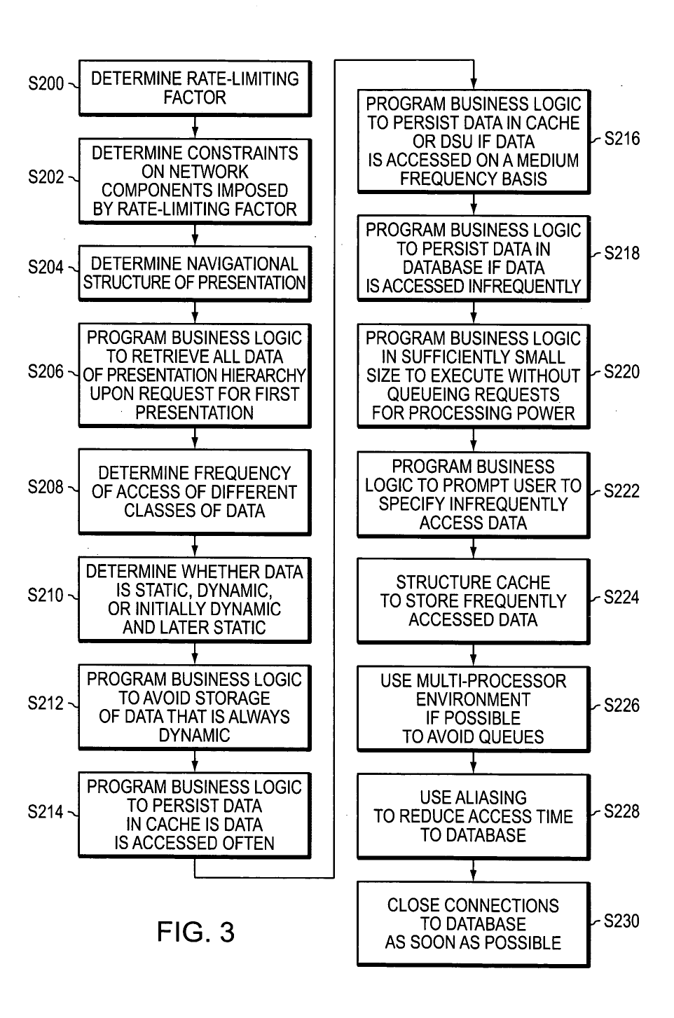

FIG. 3 is a method in accordance with the invention. In Step S200 the rate-limiting factor of the computing environment 2 is determined. As previously described, the rate-limiting factor can be the connection between the user device 4 and the server 6, the execution speed of the processor(s) 42, 43, 44, 45, or the data access time required for the server 6 to access data 40 in the data storage device 8. In Step S202 the constraints on the network components imposed by the rate-limiting factor are determined. This will mean that requests and data uploaded or downloaded from the user device 4 to the server 6, and vice versa, should not exceed the ability of the transmitting or receiving equipment to handle it, resulting in queuing of data awaiting reception and transmission with resulting slower transmission rates than would otherwise be attainable. Alternatively, if the rate-limiting factor is the processing speed of the processor(s) 42, 43, 44, 45, then the amount of code executable by the processor(s) per request must be sufficiently limited so that the processor(s) can execute the average number of requests the server 6 is required to respond to over a given period of time to avoid queuing of requests. If the data access time is the rate-limiting factor, then care must be taken to ensure that the number of data requests generated by the server 6 does not exceed the ability of the data storage device 8 to respond, resulting in queuing of data access requests which could greatly slow data access times. In Step S204 the navigational structure of the presentations 38 is determined. In other words, the lead presentation and all subsequent presentations which are linked to it are determined. In Step S206 the business logic is programmed to retrieve all data corresponding to fields of the presentations from the data storage device 8 to the server 6. In this manner, the data not only for the requested presentation, but also the data for the entire presentation hierarchy, can be obtained so that the server 6 is much more responsive to subsequent requests for data in that hierarchy. Optionally if they are stored in the device 8 as opposed to being generated or stored in the server 6, the business logic 78 can be programmed to retrieve the presentations as well. In Step S208 the frequency of access of different classes of data is determined along with their persistence. In Step S210, it is determined whether data is static, dynamic, or initially dynamic and later static. If the data is accessed frequently, whether variable or fixed, it can be stored in the cache of the server 6. If the data is accessed with medium frequency, then it can be stored in cache or the DSU while dynamic and in the DSU when it becomes fixed. If the data is accessed infrequently, then it can be stored in the data storage device 8. In Step S212, data 40 which is always dynamic can effectively be programmed into the business logic 76 to avoid unnecessary data storage and access operations. In Step S214 the business logic 76 is programmed to persist data 40 which is accessed on a high-frequency basis. In Step S216 the business logic 76 is programmed to persist data in cache 72 or DSU 48 if such data is accessed by the processor(s) 42, 43, 44, 45 on a medium-frequency basis. In Step S218, if the data 40 is accessed on a relatively low-frequency basis, then the business logic 78 is programmed to store such data in the data storage unit 86 of the device 8. In Step S220 the business logic 78 is programmed to prompt the user 14 to specify infrequently accessed data that the user desires to retrieve. By prompting the user 14 to specify the infrequently accessed data 40 with one or more relatively specific parameters, searching in the database stored in data storage device 8 can be reduced so that less processing capacity on the part of data storage device 8 is consumed in searching for the data sought by the user. In step S222 the business logic 78 is programmed in modules 126₁-126_{N} of sufficiently small size in terms of the amount of code and machine instructions cycles required for each, so that queuing of modules awaiting processing is avoided. In Step S224 the cache 72 is structured to store relatively high-frequency of access data 40, or more specifically, data 40 that the user has or is likely to access during a session. This can be done by creating an array 129 in the cache 72 of the memory 72 upon boot-up of the server 6, and storing a session identifier 125 created in response to a user's authentication to the server 6 by presenting credential data 129 such as a user name and password or digital certificate. Frequently accessed data 40 for the user 14 can be stored in association with the respective session identifier 125 so that the server 6 is able to respond relatively rapidly if the user 14 requests such data. In Step S226 a multi-processor configuration is used for the server 6 if possible under the circumstances. In Step S228 aliasing is used to reduce data access time to the data storage device 8. In other words, the server 6 selects an IP address from a group of IP addresses and uses same to access a data storage device 8 with a data request. As soon as the server 6 has received the requested data from the data storage device 8, in Step S230, it closes the connection 130 to free the IP address for use in generating another data request. Use of these steps in the computing environment 2 greatly enhances responsiveness to user requests for data.

Data Storage Device and Corresponding Data Structure

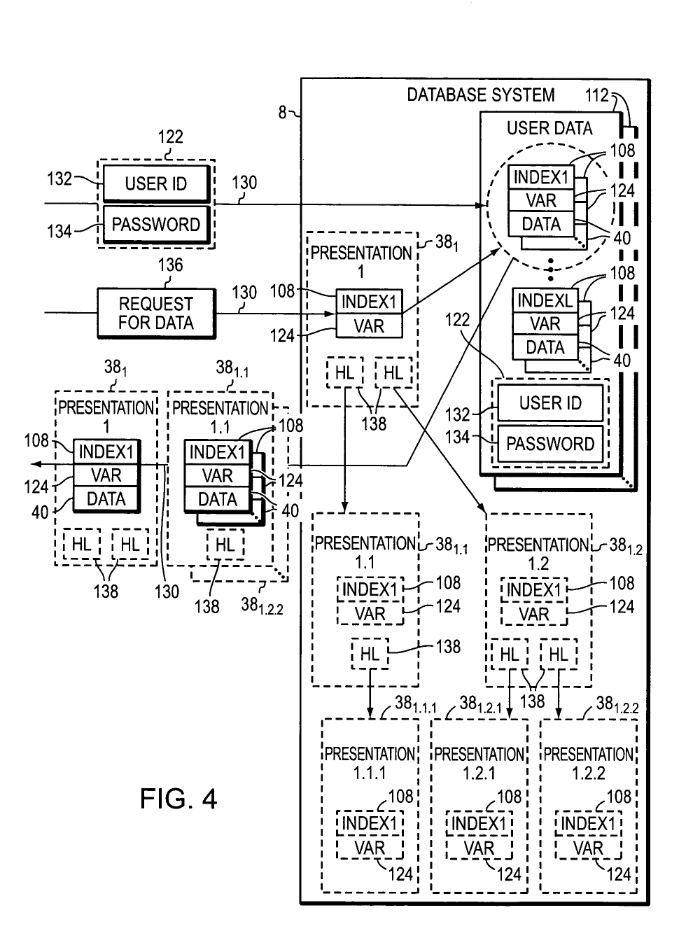

FIG. 4 is a view of the data storage device 8 and the data 40 stored therein. In this example, it is assumed that the user 14 has input credential data 131 using the user device 4, and has submitted same to the server 6 via the network 10. In turn, the server 6 has supplied the data storage device 8 via the network 12 with the credential data 131. The credential data 131 maps to user data 112 which includes data pertaining to the user identified by the credential data. The user 14 generates a request for data 136 which is transmitted to the server 6 via the network 10. The server 6 transmits this request 136 by the network 12 to the data storage device 8. The data storage device 8 generates a query based on this data. In this case, the request for data is associated with a presentation 381. This presentation 38₁, like all others 38_{1.1}, 38_{1.2}, 38_{1.1.1}, 38_{1.2.1}, 38_{1.2.2}, in its hierarchy, contains an index 108 along with the variable name 124 in the metadata thereof. The data storage device 8, or more specifically, the processor 80 thereof, uses the index 108 and variable name 124 to reference the user data 112 in order to obtain the corresponding data 40. It should be understood that the user profile 112 can contain data 40 which is not within the presentation hierarchy of the requested data. Thus, the index 108 can be used to distinguish data 40 within the hierarchy of the requested data from other data 40 stored in the user profile 112. The requested data 40 is transmitted to the server 6 for population of the corresponding presentation. In addition, the data storage device 8, or more specifically, the database server 96 executed by the processor 80, is programmed to provide the data 40 in the presentation hierarchy 38₁, 38_{1.1}, 38_{1.2}, 38_{1.1.1}, 38_{1.2.1}, 38_{1.2.2} to the server 6 via the network 12. The server 6 then uses the data for the requested presentation to populate the corresponding fields of this presentation and serves the same to the user device 4 via the network 10. The user device 4, or more specifically, the output device 26 thereof, presents the presentation with populated data 40 to the user 14 via the browser 36.

It is possible that the data storage device 8, rather than merely storing data 40, can store the presentations themselves and provide user presentations along with corresponding data to the server 6 via the network 12 upon request for the lead presentation 38₁ of the hierarchy. The server 6 then has access to these presentations in case any one of them is requested by the user.

As another possible alternative, rather than using the index 108, the server 6 and/or data storage device 8 can be programmed to determine a presentation hierarchy by following the links to other pages indicated by the “href=” or other such identifier in the mark-up language used to code the presentation, such as HTML. The variable names for all presentations in the hierarchy can thus be obtained and referenced against the corresponding user data in order to obtain all possible data and/or presentations for a particular user.

Storage of Data Based Upon Its Frequency of Access and Persistence

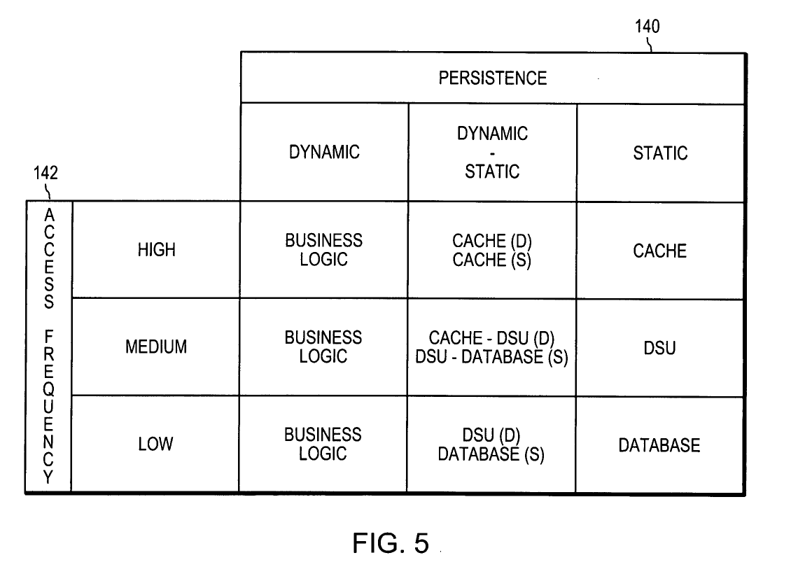

FIG. 5 is a table showing the relationship between persistence of data, designated numeral 140, as opposed to frequency of access, designated numeral 142. As shown in the table, if data is always dynamic, then it is in effect associated with a variable that can be programmed in business logic 78 regardless of whether its frequency of access is high, medium, or low. With respect to data that is initially dynamic and later becomes fixed or static, if it is accessed on a high frequency basis, such data is stored in the cache 72 of the server 6 whether it is dynamic or static. In the case in which the data is initially dynamic and becomes static and is accessed with medium frequency, such data is initially stored in the cache 72 and/or DSU 48 when the data is dynamic, and is later stored in the DSU 48 when it becomes static. For data that is initially dynamic and later becomes static and is accessed with low frequency, such data is stored in the DSU 48 while dynamic and later stored in the data storage device 8 when it becomes static. In the case in which the data is static, if it is accessed with high frequency, it is stored in the cache 72. If it is accessed with medium frequency, it is stored in the DSU 48. If it is accessed with low frequency, then such data is stored in the data storage device 8. High, medium, and low frequency of access data is defined by the core and ancillary functions of the application. If the data is responsive to the user's purpose in using the application to begin with, then this data is properly defined as high frequency of access data. For example, if the application 122 provides a “check account” link, then data associated with this core function of the application can be retrieved and stored in the cache 72 in response to the user 14 “logging in” or the user requesting a link that leads to a presentation providing such function. In this example, high frequency of access data can include current account balance, debits and credits for the current monthly period, etc. Medium frequency of access data can include secondary or ancillary information, such as check number, check date, and transaction date for the current monthly period, as well as data from the previous period. Data accessed on a low frequency basis is generally ancillary data not related to a core function of the application 122, and could include data 40 older than the previous monthly period, as the likelihood of the user requesting such data is relatively low. Although FIG. 5 indicates the considerations under which data 40 is to be stored in the server 6 and data storage device 8 prior to a user establishing a session, if during a session a user requests particular data 40, then all such data as well as other data in the related presentation hierarchy, are moved from the DSUs 48, 86 into the cache 72 in association with the appropriate session identifier 125 as the user's action has indicated that such data will be or is likely to be accessed. After the session is terminated, the corresponding data can be cleared from cache 72 or overwritten by data for a subsequently established session.

Cache Structure

FIG. 6 indicates the structure of data 40 stored in the cache 72. This data 40 is stored in rows corresponding to session identifiers 125₁-125ₓ, x being a positive integer. Hence, at least the data 40 that accessed by each user associated with a session identifier 125 for respective users 14 are listed in correspondence with variable name 124 and associated data 40. For example, the first row first column for session ID 1 indicates that the variable name “ACCTBAL” is associated with data 40 with a value of “1998.97.” As much as fifty percent of the cache 72 can be dedicated to providing space for data 40 associated with a respective active session, to greatly improve responsiveness of the server 6 to user requests for data.

Sizing Application Modules to Avoid Queuing and Unnecessary Latency

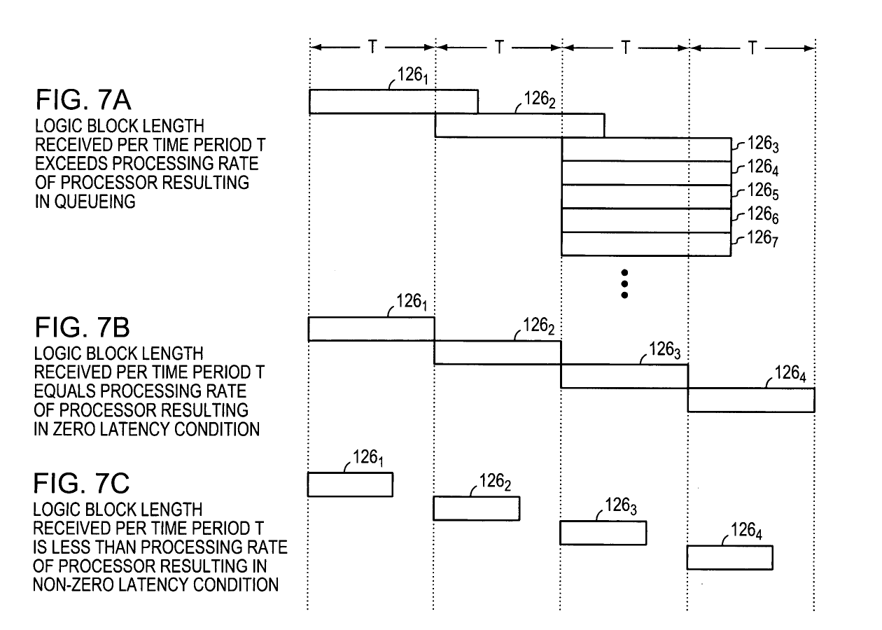

FIGS. 7A-7C are respective diagrams for describing the problems of queuing and unnecessary latency with respect to processing data requests, and how such data processing can be performed to avoid such problems. Specifically, in FIG. 7A, the logic block length or module received per unit time exceeds the processing rate of the processor, resulting in queuing of modules for execution. More specifically, as shown in FIG. 7A, the time required to execute the module 126 exceeds the period T corresponding to the period of time available to the processor to execute the module before receipt of the next module. In this particular example, after three time periods T, queuing results for modules 126₃-126₇ because the processor(s) 42, 43, 44, 45 is unable entirely process a module 126 before a subsequent module is received for execution by the processor(s). Queuing is undesirable because it requires processing resources to manage the queuing, which further detracts from the optimal data and instruction processing throughput that could be obtained in the absence of such queuing.

FIG. 7B shows the case in which the processor(s) 42, 43, 44, 45 is just able to process the receipt module 126 before the next is received for processing. This condition corresponds to the maximum data processing output obtainable by the processor(s), and is generally represents the optimal situation in which the processing power of the processor(s) is fully utilized to process data without the occurrence of queuing.

FIG. 7C shows a different condition in which the average module 126 can be executed well before the next module is received for processing, resulting in significant periods of latency at the end of each period. In cases in which the latency can be used for other operations by the processor(s), the processing power can be fully utilized. However, in those cases in which the Processor(s) 42, 43, 44, 45 are unoccupied for significant periods of time, an inefficient use of such processor(s) can result. Thus, ideally, the processor(s) should be able to execute the modules 126 and have sufficient time available to handle all other tasks with which the processor(s) must carry out, to avoid queuing of data requests.

Use of Aliasing to Avoid Queuing of Data Access Requests

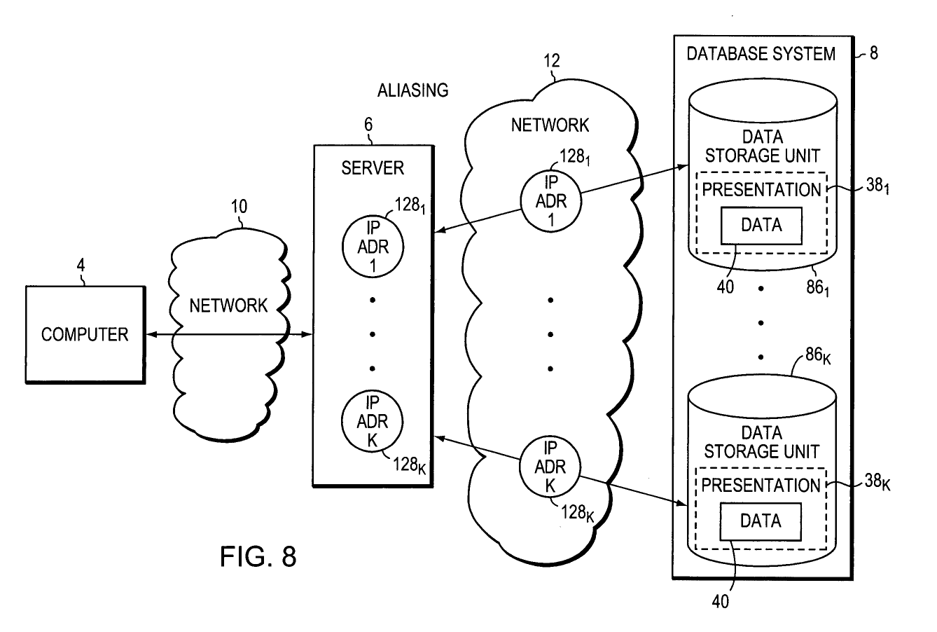

In FIG. 8, the concept of aliasing is illustrated diagrammatically. The user device 4 generates requests for data 40, optionally presented in one or more presentations 38, to the server 6 via the network 10. The server 6 generates data requests to the DSUs 86₁-86ₖ of the data storage device 8. By using the pool of IP addresses 128₁-128ₖ, the server 6 is able to avoid queuing of data requests which would otherwise occur if a single IP address were used to access all of the DSUs 86₁-86ₖ. The server 6 can thus generate one or more data requests using respective IP addresses 128₁-128ₖ of a pool used by the server 6. When the data 40, optionally with presentation(s) 38, is returned from the DSU 86₁-86ₖ identified by the IP address used for the data request to the server 6, the server 6 closes the socket connection to free the IP address for another data request. The use of aliasing thus provides a major advantage over only using a single IP address to access all of the DSUs 86₁-86ₖ in that queuing of data access requests from the server 6 to the data storage device 8 can be avoided.

Data Presentation

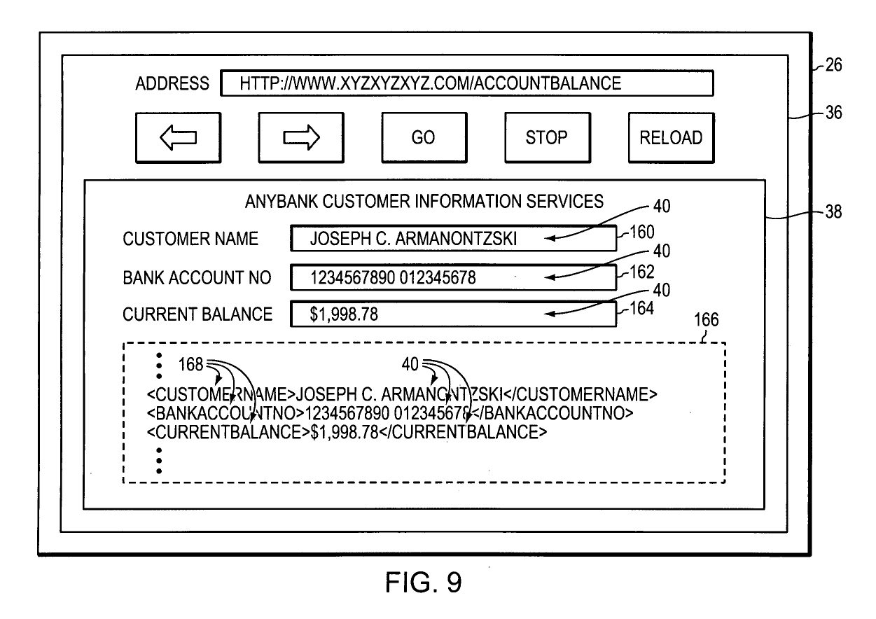

FIG. 9 is an exemplary view of a presentation generated by browser 36 on the output device 26 of the user device 4 to present or display data 40 responsive to a user request. As is common in web browsers, the browser 36 includes an address field for entering the uniform resource locator (URL) or uniform resource identifier (URI) indicating the network address of a resource, such as data 40, on the Internet. As is also common on web browsers, the browser 36 has various control soft buttons, include forward and backward arrows for navigation through previously requested presentations, as well as a “Go” button to commence a request for access to the URL or URI identified in the browser's address field, a “Stop” button to halt a current request, and a reload button to request reloading of a resource such as a presentation 38 and/or data 40, at a URL or URI identified in the browser's address field.

In the example of FIG. 9, it is assumed that the user 14 has requested data pertaining to his/her bank account balance from the server 6 and data storage device 8 by indicating the URL or URI for this resource in the address field of the browser 38. In response to the user's request via user device 4, the server 6 retrieves the data 40 responsive to such request. If the user's request is for a presentation in a hierarchy previously requested by the user, then the server 6 has already retrieved the responsive data from the data storage device 8 and can readily obtain same from its memory 50 or DSU 48. If instead no request has been made for this data within the current session, then the server 6 can request this data 40 from the data storage device 8, along with all other data in its hierarchy, and optionally can request a series of related presentations from such device. The data storage device 8 responds with the appropriate data 40 and optionally also corresponding presentation(s) 38, and provides same to the server 6. The server 6 populates a presentation 38 with the data 40 using the index and variable names therefor, and provides same to the user device 4 for display. Thus, in FIG. 9, the presentation 38 is displayed on the output device 26 of the user device 4. In this example, which is provided by way of illustration and not limitation as with all other examples disclosed herein, the presentation 38 displayed on the browser 36 includes fields 160, 162, 164 populated with respective data 40, i.e., “Joseph C. Armanontski,” “1234567890 012345678,” and “$1,998.78.” As shown in the source code 166 for the presentation 38, the fields 160, 162, 164 are associated with respective variable names 168 which tag the data 40, and link it to respective fields 160, 162, 164 for display of such data 40. Thus, the data 40 can be displayed in the presentation 38 and presented to the user 14 on device 4.

Operational Flows of User Device, Server, and Data Storage Device

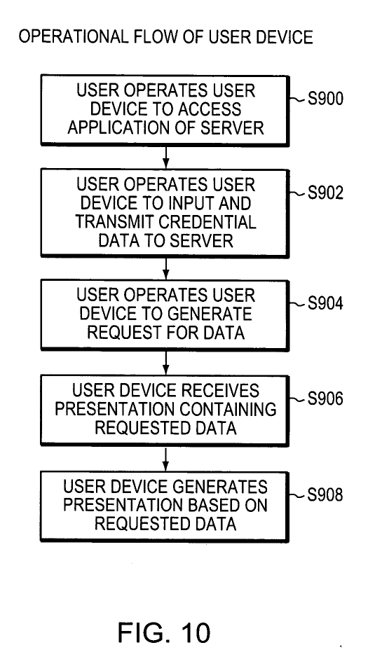

In FIG. 10 a flowchart of processing flow performed by the user device 4, or more specifically the processor 16, in conjunction with the user 14, is shown. In Step S900 the user operates the user device 4 to access application 15 via the network 10. This can be done by inputting the network address for accessing such application 15 into the browser 36 of the user device 14, or activating a hyperlink in a web page, for example. In step S902 the user operates the device 4 to input and transmit credential data 123 to the server 8 for authentication via the network 10. In Step S904, assuming the server 6 authenticates the user 14, the user operates the user device 4 to generate a request for data 40. In Step S906 the user device receives a presentation including the requested data from the server 6 via the network 10. In Step S908 the user device generates a presentation on the output device 26. Steps 904-908 can be repeated by the user 14 as desired to obtain the data 40 of interest to the user.

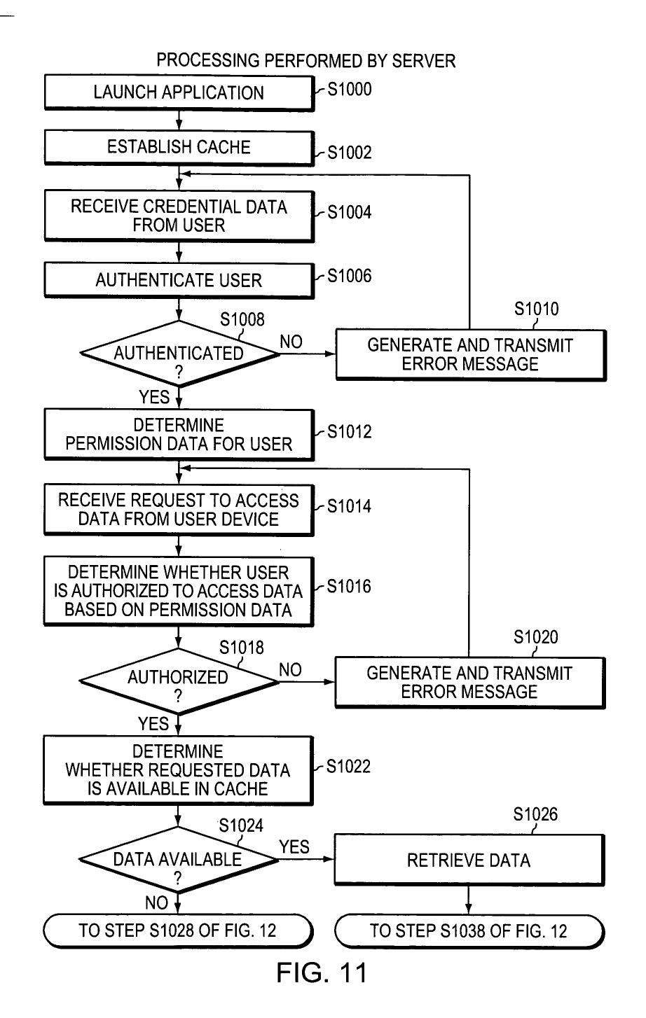

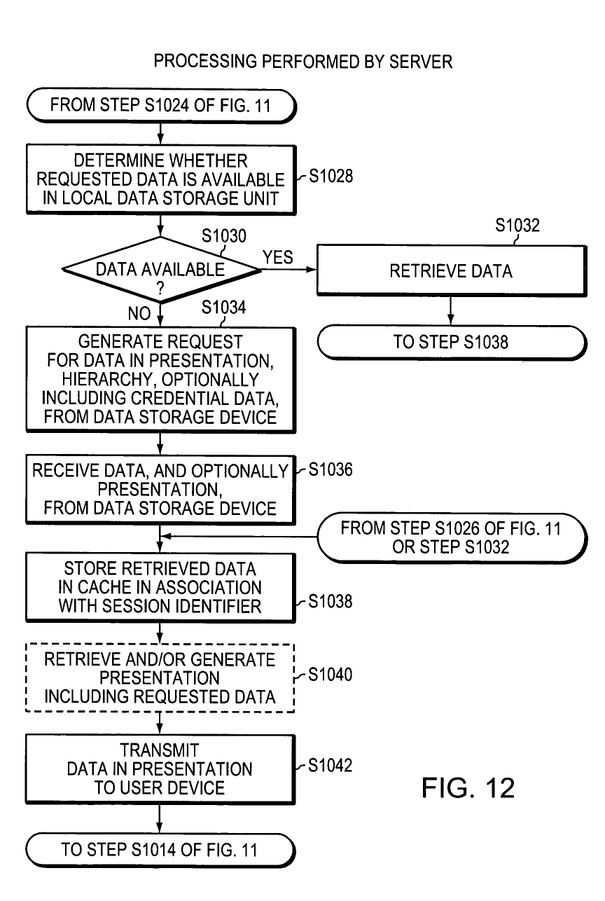

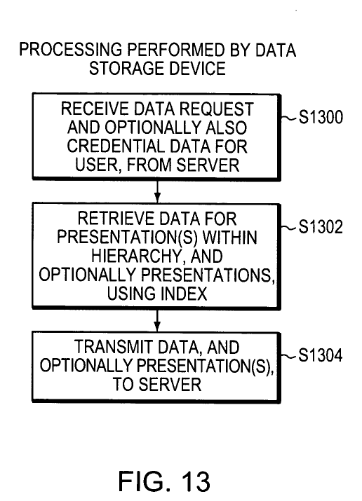

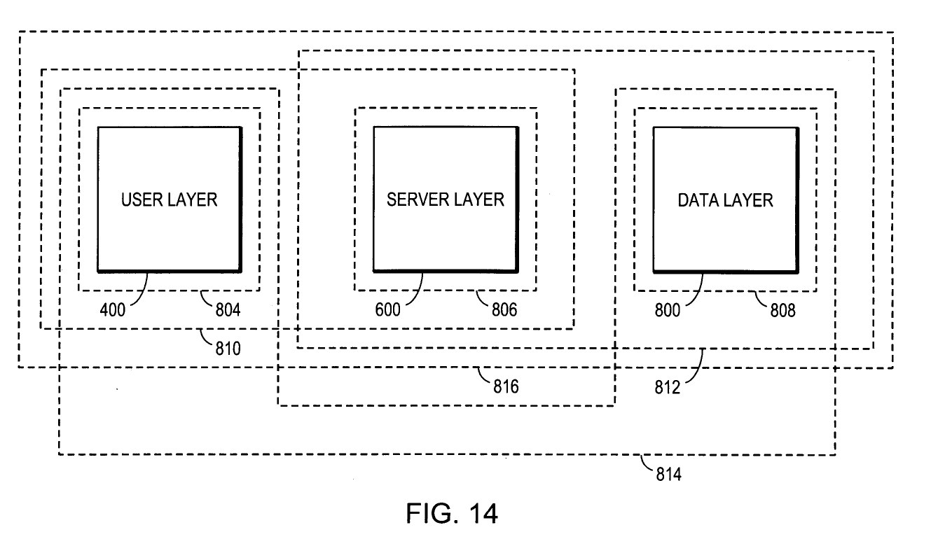

FIGS. 11 and 12 are operational flows of processing performed by the server 6, or more specifically, the processor(s) 42, 43, 44, 45 in conjunction with other elements of the server. In Step S1000 the server 6 launches the application 15. In Step S1002 the server 6 establishes the cache 72 to provide memory space for storing data 40 in association with respective session identifiers 123. In Step S1004 the server 6 receives credential data 123 from the user device 4 via the network 10. The user 14 thus indicates intent to establish a session with the server 6. In Step S1006 the server 6 authenticates the user 14. In Step S1008, if the server 6 determines that the user is not authenticated, then in step S1010 the server 6 transmits an error message to the user device 14 via the network 10 to advise the user that the credential data provided has not been recognized by the server 6, and processing returns to Step S1004. Conversely, if Step S1008 indicates that the user 14 is authenticated, then processing proceeds to Step S1012 in which the server 6 determines the permission data 127 that applies to the user and defines the rights and privileges that the user has to access particular classes of data, portions of the application, etc. These will normally be set by the server administrator for each user or class of users. In Step S1014 the server 6 receives a request to access data 40 from the user device 4 via the network 10. In Step S1016 the server 6 determines whether the user is authorized to access the requested data using the permission data 127. In Step S1018 if the user is not authorized to access the data, then the server 6 generates and transmits an error message to the user device 14 via the network 10 in Step S1020, and processing returns to Step S1014. If the user is authorized to access the data in Step S1018, then processing proceeds to Step S1022 in which the server 6 determines if the data is available in cache 72. If in Step S1024 the requested data is not available in cache 72, then processing proceeds to Step S1028 of FIG. 12. Conversely, if the requested data is available in the cache 72, then the server 6 retrieves same from the cache 72 in Step S1026 and proceeds to Step S1038 of FIG. 12. Referring to FIG. 2, if the data 40 is not available locally to the server 6 in its cache, then in Step S1028 the server 6 determines whether the requested data is available in the local data storage unit 48. In Step 1030, if such data is available in the DSU 48, in Step S1032 the server 6, or more specifically the processor(s) 42, 43, 44, 45, retrieve such data and processing proceeds to Step S1038. Returning to Step 1030, if data is not available in the DSU 48, then in Step S1034 the server 6 generates a request for such data from the data storage device 8, optionally including the credential data 123 so that the data storage device 8 can identify the data stored therein that corresponds to the user 14. In Step S1036 the server 6 receives the responsive data 40 from the data storage device 8, along with all other data in the hierarchy to which the requested data belongs, optionally together with corresponding presentation(s) 38. After Steps S1026 or S1032, the server 8 stores the retrieved data in cache 72 in association with the session identifier 125 of the user generating the request. If the presentation(s) 38 and data 40 are not retrieved in a form ready for transmission to the user device 4, in Step S1040, the server 8 generates the presentation 38 including the user-requested data 40, and transmits same to the user device 14 via the network 10 in Step S1042. Step S1040 is indicated in broken line to indicate that it is an optional step. Processing by the server 6 can terminate after performance of Step S1042 if the user indicates no further use of the application 15 is desired, or alternatively, processing can return to Step S1014 of FIG. 10 to process further data requests from the user. In FIG. 13 processing performed by the data storage device 8, or more specifically the processor 80 in conjunction with other elements of the server 8, begins in Step S1300. In Step S1300 the device 8 receives a request for data from the server 8, optionally along with credential data 127 for the user 14 that identifies a particular user profile containing data relevant to the user. In Step S1302 the data storage device 8 retrieves not only the requested data 40, but also all other data of the presentation hierarchy containing the requested data. Furthermore, the data storage device 8 can retrieve the presentation(s) for such data from the DSU 86. To retrieve the data 40 and presentation(s) 38 for the hierarchy to which the requested data belongs, the data storage device 8 can determine the index associated with the requested data 40 by the stored association in DSU 86, then search the database 116 for any data and presentations having this same index. Once this data is collected, in Step S1304, the data storage device 8 transmits the retrieved data 40, and optionally associated presentation(s) 38 if these are stored in the device 8, to the server 6 via the network 12. Processing performed by the data storage device 8 to handle the request for data from the server 6 is thereby completed. The device 8 can repeat the basic process of Steps 1300-1304 for the next data request. Advantageously, because the data storage device 8 responds with not only the requested data but also all other data within a hierarchy of presentations, the server 6 has available other data 40 that the user is likely to request to enhance responsiveness to the user.

Alternative Configurations

Those of ordinary skill in the art will appreciate that the disclosed invention can be implemented in a variety of alternative configurations. For example, instead of only one server 6, there can be numerous servers of similar configuration coordinated to implement different parts of the business logic 78 of the application 122. As another possibility, one or more additional servers 6 can operate to provide the same application 122 to different users operating respective devices 6. Thus, the capabilities of the server 6 can be scaled by providing one or more additional servers operating in coordination with one another, or with different users or user groups.

In addition, as shown in FIG. 13, it should be understood that the functions of the user device 4, server 6, and data storage device 8 can be abstracted into respective user, server, and data layers 400, 600, 800 of software that are executed by respective processor-based hardware such as units 4, 6, 8. The user layer 400 incorporates the browser 36 and the presentations 38 executed by such browser. The server layer 600 incorporates the application 122 and its business logic 78. The data layer 8 incorporates the database server 96, persisted data 116, and optionally presentations 38 if stored therein.

In current distributed computing environments it is often the case that software is executed on different computing devices in a network. In fact, parts of a single software module can be distributed to different hardware units for execution, and the results of such execution coalesced so that the result is virtually the same as could be accomplished if the module(s) were all executed on the same hardware unit. Thus, the software can be written in a high-level language, distributed to a processor-based computing device, then interpreted according to the specific computing device in which the software is executed. For example, Java code can be written as byte code that is distributed to a computing device with a Java Virtual Machine (JVM) that interprets the byte code into a form usable by the specific hardware of the computing device. By providing different interpreters within the JVM, the same byte code can be executed on totally different OS/OEs and hardware units with virtually the same result.

Hence, in FIG. 13, the user layer 400, server layer 600, and data layer 800 can be executed on respective computing devices 804, 806, 808. Alternatively, user layer 400 and server layer 600 can be executed on the same computing device 810, and the data layer 800 can be executed on the computing device 808. As yet another alternative, the user layer 500 and server 600 can be executed on computing device 810, and the data layer executed on computing device 808. As a further alternative, the user layer 400 and the data layer 800 can be executed on computing device 814, and the server layer 600 can be executed on computing device 806. It is even possible that the user layer 400, server layer 600, and data layer 800 can be executed on the same computing device 816. These options are intended to be included within the scope of the invention except where specifically excluded by relevant claim limitations.

It should further be understood that if time required for the server 6 (or layer 600) to access all data in the data storage device 8 (or layer 800) would exceed the target response time to a user's request if all relevant data 40 were retrieved from the data storage device 8, then it is possible to break the request into requests for smaller portions of data. Thus, the server 6 can initially obtain as much data 40 as is necessary to respond to the user's request and some or all additional data that has not been requested that can be retrieved without exceeding the target response time to the user. The server 6 can provide the requested data 40 to the user device 4 for presentation to the user 14, and all frequently accessed data 40 retrieved by the server 6 can be stored by the server in its cache 72. The server 6 can generate one or more additional requests to the data storage device 8 to retrieve some or all remaining frequently-accessed data 40 for the requesting user. The server 6 thus has this data available in its cache so that, upon request of the user, such server can provide requested frequently-access data to the user 14 relatively quickly. The user 14 thus experiences relatively fast response to his/her requests for data from the server 6.

It should be appreciated that the nature of a presentation in a hierarchy can be interpreted broadly. A presentation hierarchy can be defined as a group of hyperlinked web pages. Alternatively, the presentation hierarchy can be a group of linked legacy or “green” screens. Furthermore, the presentation hierarchy can be a group of linked sonic message files for a telephone call center, etc. in which a user operates a telephone keypad to enter data and select options through an aural menu presented to the user (in this case, the user device 14 can be a telephone handset or other device with telephone capability). Thus, the nature of the presentations in a navigational hierarchy can be broadly defined, and can even be a hybrid group of different types of presentations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### Conclusion

Software applications are written to accomplish a specific purpose, and if one designs the architecture of computing environment 2 in accordance with the invention, then the server 6 will retrieve the data 40 responsive to accomplishing that purpose from the data storage device 8 as soon as it becomes clear that the user 14 intends or is likely to access this data. In many applications, such intent is known as soon as the user “logs in.” For example, if the application is programmed to permit a user to check an account balance online, then it may be clear as soon as the user logs in that the user will eventually request the current account balance. Such data 40 can be retrieved by the server 6 from the data storage unit 8 upon the server 6 authenticating the user. In other applications, the user may activate a particular link which makes clear what data the user intends to access. The server 6 then retrieves responsive data 40 from the database storage device 8 as soon as the server 6 has determined it is likely that the user will access this data. For example, if the link is from a home page and is entitled “check current account activity” then it is clear that the user will access account transactions for the current period and the responsive data can be retrieved by the server 6 from the data storage device 8.

How quickly the server 6 and data storage device 8 respond to a user request for data 40 depends upon the rate-limiting factor in the computing environment 2. This rate-limiting factor can be, and normally is in current network environments, the speed of data transmitted on connection 118 due to the common use of 56 Kbps modem 28 in the user device 4. In other cases, the rate-limiting factor can alternatively be the speed of the processor(s) 42, 43, 45 in the server 6 and their ability to handle the number of users 14 accessing the server 6 via respective computing devices 4. The rate-limiting factor can also be the response time necessary for the server 6 to retrieve data 40 from the data storage device 8. If one designs the architecture by identifying the rate-limiting factor and designing for the best performance possible based on the rate-limiting factor, then effective (i.e., the computing environment works), efficient (i.e., requiring the least number of resources), and cost effective (i.e., the least costly to implement) network architecture 2 can be obtained. Techniques toward obtaining this objective include breaking business logic code segments into modules sufficiently small to avoid queuing of instructions in the processor(s) 42, 43, 44, 45. Another is to program the server 6 to anticipate the data and presentations the user will request by observing the user's operation of user device 4 and retrieving not only requested data, but also data that it is likely the user will subsequently request. Data organization by indexed presentation hierarchy helps to reduce the time needed for the server 6 to retrieve data from the data storage device 8. In addition, when low frequency of access data is requested, the presentations can be designed to prompt the user to enter relatively specific information regarding the data to be requested, such as “check number” or “check date,” for example. By having the user enter data that is specific pertaining the data sought, requiring the data storage device 8 to search through relatively large amounts of data caused by ambiguous requests can be avoided, thus improving response time to the user. The processor(s) 42, 43, 44, 45 can be programmed to perform multiple operations simultaneously. For example, by breaking a user's data request into multiple modules, the responsive data and presentation can be served to the user's device faster than otherwise. By breaking the application 122 and/or business logic 78 into relatively small modules 126, it is possible to instantiate such modules quickly. Further, by making the modules 126 as self-contained as possible, meaning with defined inputs and outputs without having attributes and data that are interdependent between different modules, queuing of modules can be avoided. In addition, by abstracting the function provided by a module (e.g., “insert” as opposed to “insert character,” “insert word,” “insert sentence,” “insert paragraph” and the like) to make it common across different applications, the module can be readily repurposed for use in another application without requiring significant rewriting of the code. In addition, maintenance costs associated with updates and the like can be lessened.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
determining a rate-limiting factor of a computing environment including at least one user device, a server, and a data storage device, the rate-limiting factor being at least one of a data rate of a connection between the user device and server, instruction and data processing speed of at least one processor in the server, and data access time required to generate and transmit a data request to the data storage device and receive responsive data from the data storage device at the server;
determining at least one constraint on the user device, server, and/or data storage device based on the rate-limiting factor, the constraints related to the time required to download a presentation with data from the server using the user device, the time required to execute a module by the user device, and the time required for the server to access and retrieve data from the data storage device; and
implementing the user device, server, and/or data storage device to meet the determined constraints.

2. A method as claimed in claim 1 further comprising:
determining a navigational hierarchy of presentations; and
programming the server to retrieve all data associated with a user for the hierarchy of presentations upon a request for the lead presentation of the hierarchy so that such data can be used to populate the presentations of the hierarchy upon request by the user.

3. A method as claimed in claim 1 further comprising:
determining the frequency of access of different classes of data;
determining whether persistence of the data as always dynamic, initially dynamic but later static, or always static;
storing data in the server and data storage device based on the determined frequency of access of different classes of data and the persistence.

4. A method as claimed in claim 1 further comprising:
programming the business logic of the server to have modules sufficiently small in size to be executed in response to a data request from a user of the user device so that the server responds within a predetermined period of time determined to be acceptable to the user.

5. A method as claimed in claim 4 wherein the modules are sufficiently small to be completely executed for a data request at the highest expected frequency of data requests in the network environment.

6. A method as claimed in claim 1 wherein the modules are sufficiently small in terms of the amount of code therein to be completely executed per data request at the highest expected frequency of data requests in the network environment.

7. A method as claimed in claim 1 wherein the server is selected to have a multi-processor configuration.

8. A method as claimed in claim 1 wherein the server uses a plurality of internet protocol (IP) addresses to address data in the data storage device.

9. A method as claimed in claim 8 wherein the server closes connections to the database as soon as the responsive data is received from the data storage device.

10. A method comprising:
determining a navigational structure of presentations; and
programming the server to retrieve all data associated with a user for the determined hierarchy of presentations upon a request for the lead presentation of the hierarchy so that such data can be used to populate the presentations of the hierarchy upon request by the user.

11. A method as claimed in claim 10 wherein at least one of the presentations is a web page.

12. A method as claimed in claim 10 wherein at least one of the presentations comprises a data file.

13. A method as claimed in claim 10 wherein at least one of the presentations comprises a graphics file.

14. A method as claimed in claim 10 wherein at least one of the presentations comprises a sound file.

15. A method as claimed in claim 10 wherein at least one of the presentations comprises a video file.

16. A method comprising:
determining the frequency of access of different classes of data;
determining persistence of the data as always dynamic, initially dynamic but later static, or always static;
storing data in the server and data storage device based on the determined frequency of access of different classes of data and the persistence.

17. A method as claimed in claim 16 wherein at least one of the presentations comprises a web page.

18. A method as claimed in claim 16 wherein at least one of the presentations comprises a data file.

19. A method as claimed in claim 16 wherein at least one of the presentations comprises a graphics file.

20. A method as claimed in claim 16 wherein at least one of the presentations comprises a sound file.

21. A method as claimed in claim 16 wherein at least one of the presentations comprises a video file.

22. A system for use with at least one network, the system comprising:
at least one user device operable by a user to generate a data request;
a server coupled to receive the data request from the user device via the network, and storing business logic in modules sufficiently small to be executed without queuing of instructions to process the data request, the server programmed to refer to a cache or data storage unit (DSU) thereof to obtain the data requested by the user, the data stored in the cache or DSU according to persistence and frequency of access, and if the data is not available in the cache or DSU, the server generating a request for the data of a lead presentation and all presentations in a hierarchy thereunder; and
a data storage device coupled to receive the forwarded data request from the server, and retrieving data responsive to the server, the data including data for a presentation hierarchy including all data that can be accessed by the user for the lead presentation and presentations linked thereunder and providing the same to the server over the network.

23. A system as claimed in claim 22 wherein the server has a multi-processor configuration.

24. A system as claimed in claim 22 wherein the server uses a plurality of internet protocol (IP) addresses to address data in the data storage device to avoid queuing of data requests.

25. A system as claimed in claim 22 wherein the server closes connections to the database as soon as the responsive data is received from the data storage device.

26. An apparatus as claimed in claim 22 wherein the server stores the data retrieved from the data storage device in the cache of the server during a session with the user.

27. An apparatus comprising:
a server having a memory and a data storage unit (DSU), and programmed to store data used by such server amongst the memory and DSU according to frequency of access and persistence of the data.

28. An apparatus as claimed in claim 27 wherein data that is always variable is associated with a variable in the business logic of an application executed by the server, and is not persisted in the memory, DSU, or external data storage system.

29. An apparatus as claimed in claim 27 wherein the memory comprises a cache for storing the data accessed on a relatively high frequency basis.

30. An apparatus as claimed in claim 27 wherein the DSU stores data accessed less frequently than the data stored in the memory.

31. An apparatus as claimed in claim 27 wherein data that is accessed on a low frequency basis is stored in an external data storage unit.

32. An apparatus as claimed in claim 27 wherein the business logic modules executed by the server are sufficiently small so as to be executable in a time period sufficiently small to avoid queuing of threads for execution.

33. An apparatus as claimed in claim 27 wherein the business logic module generates a request for all data in a presentation hierarchy to an external data storage device in response to a user request for a lead presentation in the hierarchy.

34. An apparatus as claimed in claim 27 wherein the server receives credential data from a user of a user device over a network, and transmits the credential data to an external data storage device to identify a user profile having data related to the user.

35. A data storage device comprising:
a data storage unit storing data in at least one user profile, the data associated with an index identifying a presentation hierarchy to which the data belongs, and at least one variable name identifying a field of the respective presentation for population with the data.

36. A data storage device as claimed in claim 35 further comprising:
a processor coupled to the data storage unit, the processor responsive to an external request for data and retrieving the requested data and additional data included in the corresponding presentation hierarchy, the processor responding to the external request for data by providing the requested and additional data.

37. A data storage device as claimed in claim 36 wherein the external request is generated by a server and received by the processor from such server over a communications network.

38. A data storage device as claimed in claim 36 wherein all additional data included in the corresponding presentation hierarchy is retrieved by the processor from the data storage unit in response to the external request.

39. A data storage medium storing data in accordance with the frequency of access and persistence of the data.

40. A data storage medium as claimed in claim 39 wherein the data is selectively stored in the data storage medium in dependence upon whether the data is accessed on a low, medium, or high frequency basis.

41. A data storage medium as claimed in claim 39 wherein the data storage medium is a cache that stores data accessed on a high frequency basis.

42. A data storage medium as claimed in claim 39 wherein the data storage medium is a data storage unit (DSU) that stores data accessed on a medium frequency basis.

43. A data storage medium as claimed in claim 39 wherein the data storage medium is a data storage device storing data accessed on a low frequency basis.

44. A data storage medium as claimed in claim 39 wherein the persistence of the data includes dynamic, static, and initially dynamic and later static.

45. A data storage medium as claimed in claim 39 wherein the data storage medium stores data that is static.

46. A data storage medium as claimed in claim 39 wherein the data storage medium stores data that is initially variable, but does not store the data when it becomes fixed.

47. A data storage medium as claimed in claim 39 wherein the data storage medium stores data that was initially variable, but has become fixed.

48. A data storage medium as claimed in claim 39 wherein the data storage medium stores data that is dynamic.

49. A processor-readable medium storing data in at least one user profile, the data associated with an index identifying a presentation hierarchy to which the data belongs, and at least one variable name identifying a field location of the respective presentation for population with the data.

50. A processor-readable medium as claimed in claim 49 wherein the presentation hierarchy comprises at least one web page.

51. A method as claimed in claim 49 wherein at least one of the presentations comprises a data file.

52. A method as claimed in claim 49 wherein at least one of the presentations comprises a graphics file.

53. A method as claimed in claim 49 wherein at least one of the presentations comprises a sound file.

54. A method as claimed in claim 49 wherein at least one of the presentations comprises a video file.

55. A processor-readable medium storing a computer program executable by a processor to respond to a request for data by retrieving the requested data and additional data included in a presentation hierarchy containing the requested data, the processor responding to the request for data by providing the requested data and additional data.

56. A processor-readable medium as claimed in claim 55 wherein the request is generated by a server and received by the processor from the server over a communication network.

57. A processor-readable medium as claimed in claim 55 wherein the computer program is executable by the processor to determine an index corresponding to the requested data, and to use the index to retrieve all data for the presentation hierarchy associated with the index.

58. A processor-readable medium as claimed in claim 55 wherein the presentation hierarchy comprises at least one web page.

59. A method as claimed in claim 55 wherein at least one of the presentations comprises a data file.

60. A method as claimed in claim 55 wherein at least one of the presentations comprises a graphics file.

61. A method as claimed in claim 55 wherein at least one of the presentations comprises a sound file.

62. A method as claimed in claim 55 wherein at least one of the presentations comprises a video file.
